(19) United States
(12) Patent Application Publication
(10) Pub. No.: US 2004/0021086 A1
(43) Pub. Date: Feb. 5, 2004

(54) Image intensifying visual scanning device and method

(76) Inventors: Gregoire Verrier, Iselin, NJ (US); Nicolas Vezard, Metuchen, NJ (US)

Correspondence Address: ANTHONY H. HANDAL, KIRKPATRICK & LOCKHART, LLP, 599 LEXINGTON AVENUE, 31ST FLOOR, NEW YORK, NY, 10022-6030, US

(21) Appl. No.: 10/209,439

(22) Filed: Jul. 31, 2002

(51) Int. Cl. G01J 5/00

(52) U.S. Cl. 250/372

(57) ABSTRACT

An electrically powered image intensifier having an output and an input is optically coupled to the lens to receive the focused light image from the lens and provide at the output of the image intensifier an intensified light image. A chassis is configured to support the intensifier and to mainly engage the lens by engaging the mounting structure. The lens is engaged by the mounting structure in a use position. A power source is coupled to the image intensifier by an electrical switch having an open and a closed state. The switch is connected to couple electrical power from the power source to the image intensifier in the closed state and to decouple electrical power from the power source from the image intensifier in the open state. The electrical switch comprises an operator for configuring the electrical switch in the open state in an open operator position or in a closed state in a closed operator position. The operator is biased in the open operator position. The operator is urged in the use position into the closed operator position by the mounting structure.

### FIELD OF THE INVENTION

The present invention is directed to the detection of fingerprints and other forensic evidence employing an image intensifier. More particularly, the present invention is directed to a damage resistant light imaging system that photographs and provides viewing of fingerprints and other evidence.

### BACKGROUND OF THE INVENTION

Special tools are frequently used by law enforcement personnel when evaluating a crime scene to collect forensic evidence that may be hard to see or invisible to the human eye. Examples of such evidence include bodily fluids, fingerprints on porous and non-porous surfaces, forged documents, explosive residue, and trace evidence e.g., hair, fibers, etc.

One commonly used tool is a forensic light source that utilizes fluorescent light to detect and record forensic evidence. Subjects illuminated by a forensic light source may be viewed through light filtering goggles, and the output of the source may be filtered to achieve a range of diverse functionalities and corresponding capabilities, with and without the use of chemical developers, powders and dyes.

A recently introduced tool complementary to the forensic light source is a tool that relies on intensified short-wave ultraviolet (or “uv”) reflectance instead of fluorescence. Such an ultraviolet light tool can reveal otherwise undetectable or difficult to detect evidence on non-porous surfaces where a forensic light source is not useable or the subject requires processing with powders or fluorescent dye. Such systems can increase the area that can be efficiently inspected at a crime scene.

In some conventional forensic tools that utilize ultraviolet light reflectance from an ultraviolet light source a traditional photograph is taken at the output of an intensifier tube. However, photography at the output of an intensifier is limited in resolution by the number of line pairs/mm in the specification of the intensifier.

One ultraviolet light tool that does not rely on the output of an intensifier to obtain a photograph is the “SceneScope” (trademark) ultraviolet light imager or forensic viewer, which is a system with a modified Nikon FM2 camera. This product is available from J Y Horiba, Inc. The Scenescope utilizes an intensifier and a modified 35 mm camera to provide both non-intensified photography of reflectance of fingerprints on various backgrounds, and simultaneous intensified image focusing and viewing. An intensifier is useful to obtain the focus when using an invisible light source such as ultraviolet light (200-400 nm) or infrared (above 700 nm) since ultraviolet light or infrared images will not be visible to, and may be harmful to, the naked eye. The intensifier operates electronically to increase the luminescence of the image and provide a visible wavelength output for example on a video screen.

In a device of this type, as disclosed in U.S. Pat. No. 6,392,238 (the disclosure of which is incorporated by reference), an ultraviolet forensic viewer comprises a camera having a focusable camera lens to input ultraviolet light images to the camera, the camera being loadable with a film to capture images received from the camera lens. The spacing of the camera lens from the film, when loaded, is adjustable to focus an input ultraviolet image on the film. A camera mirror has an ultraviolet-reflective surface to reflect and image light received from the camera lens to provide a reflected ultraviolet image for use in focusing the camera lens. An image intensifier is optically coupled to the camera to receive the reflected ultraviolet image from the camera mirror and provide a viewable output. The reflected ultraviolet image is focused to the viewable output of the intensifier.

In this device, the camera lens incorporates optical elements which are ultraviolet-transmissive, optionally quartz, and one may employ an ultraviolet filter with the camera lens. The camera (optionally a single lens reflex camera) may comprise a viewing lens system to receive an ultraviolet image reflected by the camera mirror and project that ultraviolet image to the image intensifier. Optionally, an eyepiece or a video camera may be coupled to the intensifier.

### SUMMARY OF THE INVENTION

Still other image intensifying viewers generally comprise a T-shaped configuration, generally comprising an elongated member comprising a removable 35 mm lens at the end of a chassis holding an image intensifier. By “35 mm lens” is meant a lens for a 35 mm camera, that is a camera which accepts 35 mm film. If desired, the unit may be used in conjunction with an ultraviolet light source to reveal latent fingerprints or other evidence which is invisible or hard to see using only the unaided human eye.

However, one problem with image intensifying crime scene viewers is that the image intensifier is vulnerable to damage in the event of direct exposure to common levels of ambient light for a period of time. For example, an operating image intensifier may have a specification that it is able to sustain light at a given level of intensity for a specific short period of time, before suffering damage. This period of time may be on the order of sixty seconds at light levels as little as, for example, fifty millilumens on an area of one millimeter.

In the event that one wishes to change the lens on such an image intensifying crime scene viewer, the input face of the imager would be subjected to whatever ambient light conditions exist at that time. While, in principle, it is possible to remember to manually remove power from the image intensifying crime scene viewer to avoid damage, in practice this may be forgotten. Even when the user remembers to do this, under the pressure of trying to get a task done in a reasonable amount of time, or in the face of distraction on account of information being gathered or due to some other cause, the state of the image intensifying crime scene viewer may not be correctly noted and damage done to the unit. Based on the foregoing, there is a need for an improved ultraviolet light imaging system.

In accordance with the invention, an image intensifying forensic viewer, comprises a lens configured to focus light, from an object or surface being imaged, as a focused light image. The lens comprises mounting structure for mounting on the inventive viewer.

An electrically powered image intensifier having an output and an input is optically coupled to the lens to receive the focused light image from the lens and provide at the output of the image intensifier an intensified light image. A chassis is configured to support the intensifier and to mainly engage the lens by engaging the mounting structure. The lens is engaged by the mounting structure in a use position. A power source is coupled to the image intensifier by an electrical switch having an open and a closed state. The switch is connected to couple electrical power from the power source to the image intensifier in the closed state and to decouple electrical power from the power source from the image intensifier in the open state. The electrical switch comprises an operator for configuring the electrical switch in the open state in an open operator position or in a closed state in a closed operator position. The operator is biased in the open operator position. The operator is urged in the use position into the closed operator position by the mounting structure.

In accordance with the preferred embodiment of the invention, the lens is moveable, engaged by the mounting structure, between a use position and a release position which allows the release of the mounting structure and the lens.

In one embodiment of the invention, the lens transmits ultraviolet light, and the electrically powered image intensifier is sensitive to ultraviolet light and the lens is a focusable lens.

In the preferred embodiment of the invention, the lens has bayonet mounting structure configured to nest into and be rotated into engagement with mating bayonet mounting structure on the chassis.

Alternatively, the lens may have snap mounting structure configured to snap into engagement with mating snap mounting structure on the chassis. Any other suitable mechanical coupling arrangement may be employed.

A camera for presenting the output of the image intensifier to photographic film in the camera or an eyepiece functioning as viewing optics for presenting the output of the image intensifier to the eye of a viewer may be used in conjunction with the inventive viewer.

One embodiment of the present invention is an ultraviolet light imaging system that includes a camera. In this embodiment the chassis and the lens are configured to focus light from an object or surface being imaged and comprise a single lens reflex camera, comprising a camera lens and a camera body. Viewfinder optics of the type customarily used in a single lens reflex camera reflect the focused light image from the output of the image intensifier for viewing of the intensified image on the output of the image intensifier by a user.

### BRIEF DESCRIPTION OF THE DRAWINGS

An embodiment of the invention will now be described by way of example with reference to the accompanying drawings in which:

FIG. 1 is a perspective view of the inventive forensic viewer;

FIG. 2 is an unexploded perspective view showing the principal parts of the inventive forensic viewer;

FIG. 3 is a detail illustrating the operation of a protective switch for the inventive viewer;

FIG. 4 is a detail, similar to FIG. 3, showing the switch in the power applying position;

FIG. 5 is a perspective view of the inventive viewer illustrating the front of the system; and

FIG. 6 is a side plan view of the inventive viewer illustrating use with a camera;

FIG. 7 illustrates holding of the inventive viewer;

FIG. 8 illustrates an alternative embodiment of the inventive viewer; and

FIG. 9 illustrates another alternative embodiment of the inventive viewer.

### DETAILED DESCRIPTION

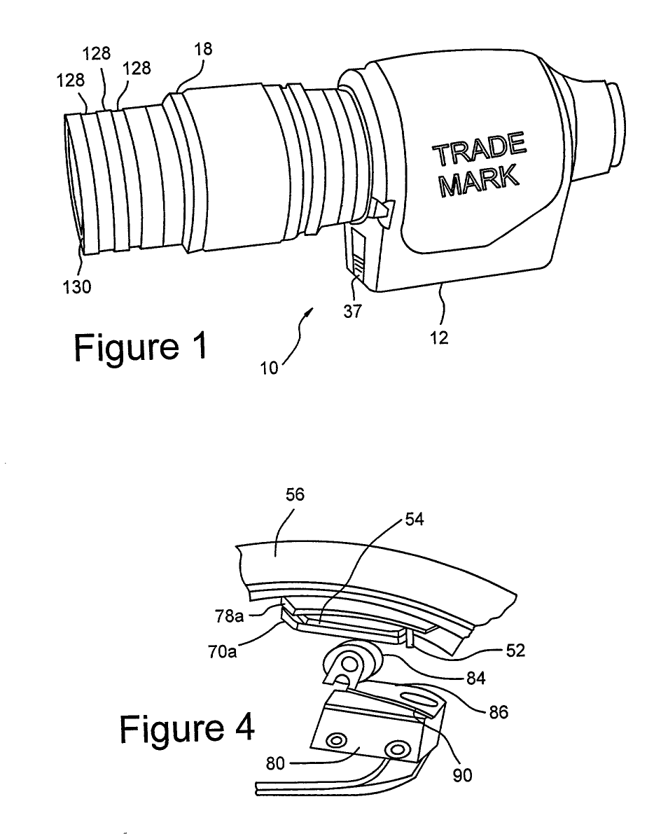

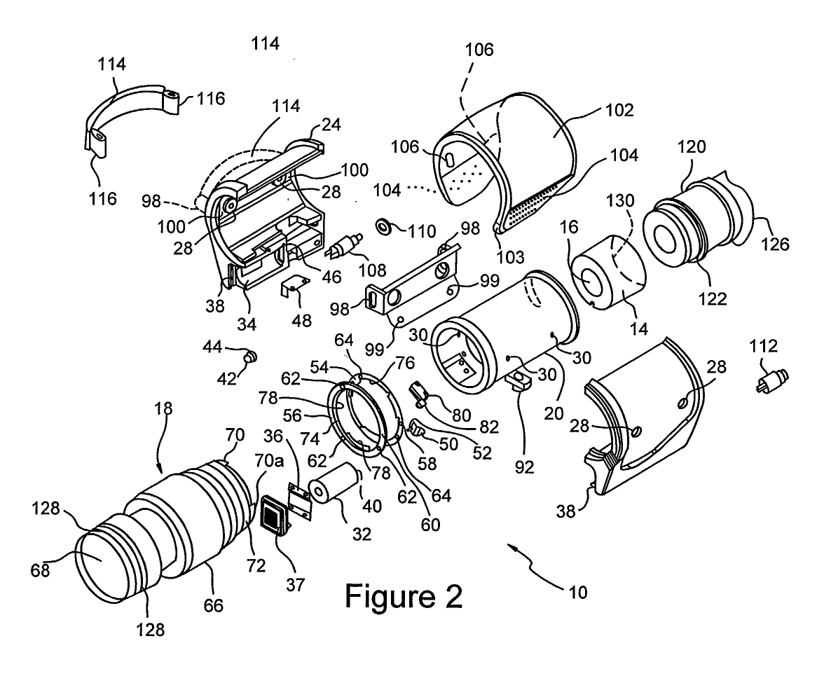

As illustrated in FIG. 1, the inventive forensic viewer 10 comprises a housing 12 which contains an image intensifier 14, as can be seen in the exploded perspective view of FIG. 2. Image intensifier 14 has an input face 16 upon which the image of an object being viewed is imaged. The image of the object being viewed is imaged by a 35 mm camera type lens 18.

Image intensifier 14 is rigidly supported within a chassis 20. Chassis 20 is rigidly supported within a housing 12. Housing 12 comprises two mating housing members 22 and 24. Mating housing members 22 and 24 are secured by screws (not illustrated) to chassis 20. These screws pass through holes 28 and anchor into tapped holes 30 in chassis 20.

Power to the unit is provided by a battery 32 which is contained within a battery receiving compartment 34 defined by mating half cavities within housing members 22 and 24. Battery 32 is coupled to the circuit by a positive terminal coupler 36 secured to a battery compartment cover 37 which is slidably held in mating recesses 38 in housing members 22 and 24. The negative terminal 40 of battery 32 is coupled to negative terminal coupler 42 which includes a loop 44 which extends around and engages wall 46 on housing member 24.

Plate 48 is made of metal and slides into positive terminal housing member 24. Plate 48 comes into electrical contact with coupler 36, when the battery compartment cover 37 is slidably held in mating recesses 38 in housing members 22 and 24. Plate 48 also has a small hole in which an electrical wire can be soldered. This wire is then connected to interlock switch 80, which controls the removal of power from the image intensifier. Plate 48 closes the electrical circuit with coupler 36, as no wire can be soldered to coupler 36, because the battery compartment cover 37 is removed to replace the battery, and it is not desirable to have any component or wire attached to it.

A key 50 is secured to chassis 20 and has a registration rod 52 for guiding the installation of springy friction member 54 and mounting ring 56 through the use of a pair of holes 58 and 60 respectively. In particular, registration rod 52 passes through holes 58 and 60 thus ensuring that they are maintained in proper relationship to each other and the rest of the system. Springy friction member 54 and mounting ring 56 are held in place by three substantially equispaced screws (not illustrated), two of which pass through holes 62 and 64 in mounting ring 56 and springy friction member 54, respectively.

Lens 18 includes a focusing cylindrical grip 66 and a number of focusing optical members 68. Lens 18 is provided with a so-called bayonet mounting comprising a number of circumferential studs 70, which extend outwardly and radially from the base 72 of the body of lens 18. Studs 70 are positioned radially to be able to pass through the inner side walls 74 and 76 of mounting ring 56 and springy friction member 54, respectively, between inwardly extending mating studs 78. Studs 70 mate with mating studs 78. More particularly, after insertion of lens 18, while it is in the angular position illustrated in FIG. 2, lens 18 is rotated clockwise into the mating position where studs 70 have their outwardly facing surfaces bearing against that portion of the outwardly facing surface of springy friction member 54 which overlies the inwardly facing surfaces of circumferential studs 70.

During installation of lens 18 onto viewer 10, rotation of lens 18 beyond the mating position is prevented by registration rod 52.

Alternatively, other lens mounting structures may be used such as screw or snap mounts.

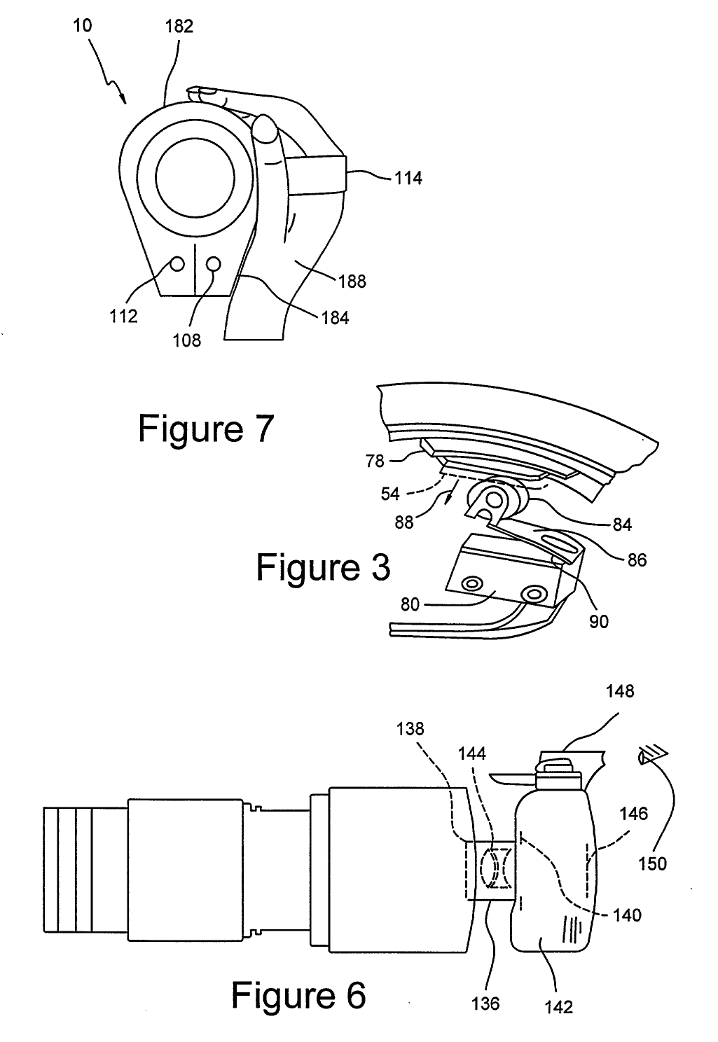

Power is coupled from battery 32 to image intensifier 14 by a single-pole single-throw switch 80 which is capable of assuming either a closed or open state. The state of switch 80 is controlled by operator 82 which is a lever which is pivotally mounted at one end and is terminated at the other end in a plastic cam follower 84. As illustrated most clearly in FIG. 3, when lens 18 is not mounted in viewer 10, cam follower 84 bears against that portion of inward surface of springy friction member 54, which faces its respective stud 78.

When lens 18 is inserted into the bayonet mounting formed by studs 78 on mounting ring 56, and rotated, studs 70 pass underneath studs 78. In the case of studs 70a and 78a, stud 70a passes between cam follower 84 and that portion of springy friction member 54 which overlies stud 78a, resulting in advancing lever arm 86 in the direction of arrow 88, moving arm 86 from the position illustrated in FIG. 3 to the position illustrated in FIG. 4. This results in the depression of switch button 90, causing switch 80 to assume the close state and conduct electricity to image intensifier 14, thus powering the image intensifier and allowing the system to operate.

Conversely, when lens 18 is rotated in the counterclockwise direction, stud 70a is also rotated in the counterclockwise direction pulling it out, from in between cam follower 84 and stud 78a, causing lever arm 86 to spring back from the position illustrated in FIG. 4 to the position illustrated in FIG. 3.

Support plate 92 is inserted into and maintained in position when housing members 22 and 24 are assembled together. Additionally, two screws (not illustrated) maintain support plate 92 in position in viewer 12. Support plate 92 is taped with a ¼×20 thread. This thread size is standard on any photographic camera. Support plate 92 is used to fix the viewer on any tripod or copy-stand when a photo must be shot and mates with the tripod camera securing belt.

Bracket 94 includes a pair of holes 96 through which the screws, which secure mating housing member 24 to chassis 20, pass. Bracket 94 also includes a pair of strap engaging loops 98 which pass through holes 100 in mating housing member 24. This allows them to extend out of the housing when the inventive viewer 10 is assembled in the manner illustrated in dashed lines in FIG. 2. Bracket 94 also includes a pair of holes 99, through which screws, which secure bracket 94 to chassis 20, pass.

A rubbery soft comfort cowl 102 overlies a relatively stiff plastic cover 103. Cowl 102 includes gripping surfaces 104 on both its sides, and also bears against a pair of elongated holes 106 through which strap engaging loops 98 extend when the inventive viewer 10 is fully assembled.

As is illustrated in FIG. 5, an on off switch 108 is secured in position by a nut 110. On-off switch 108 is a push button switch which is changed between the open and closed state by repeated depression of its associated push button which extends through mating housing member 24. In similar fashion, mating housing member 22 has a pilot light 112 mounted in it.

A strap 114, which includes a pair of fabric strap loops 116, completes the structure. Fabric strap loops 116 engage strap engaging loops 98 which may be made of metal, in contrast to most of the other structural parts which may be made of plastic. If desirable, threaded parts and chassis 20 may be made of metal. It is noted that the top surface 118 of cowl 102 is rounded to accommodate the palms and inside surfaces of the fingers of the hand of an operator of the inventive viewer 10, who has passed his through the strap 114 in the fashion of a video camcorder.

Viewing by the human eye is accommodated by an eyepiece 120, which includes threads 122 which engage mating threads 124 on the inside of chassis 20. The eyepiece 120 also includes a rubbery eyecup 126 to exclude ambient light while at the same time providing comfort to the user.

In accordance with the preferred embodiment of the invention, it is contemplated that one or more filters 128 may be attached to lens 18. The system will also accommodate a lens cap 130 which performs the function of protecting the optics of the system.

When it is desired to use the inventive system when illuminating a subject with ultraviolet light, an ultraviolet filter, such as filter 128 may be mounted on lens 18 to eliminate all but ultraviolet light from entering the system. Of course, if light produced by other physical effects are being detected, other filters, such as bandpass filters tuned to an expected wavelength range of fluorescent emissions, may be employed on lens 18.

During use, light admitted into lens 18 is focused on the front face 16 of image intensifier 14 resulting in the production of a bright image on the output face 130 of the image intensifier. This image is focused by eyepiece 120 for viewing by the human eye.

As has been alluded to above, it is contemplated that in some, but not all cases, the inventive viewer 10 will be used in connection with the observation of ultraviolet light images. Accordingly, it is desirable that lens 18 have the characteristic of efficiently transmitting ultraviolet light, and that the lens is made of suitable materials, such as quartz, and/or lenses including appropriate coatings will be used in lens 18 where operation in conjunction with ultraviolet images is desired.

In the event that lens 18 is removed from the inventive viewer 10, the rotation of lens 18 necessary for removal results in moving switch 80 from the position illustrated FIG. 4 to the position illustrated FIG. 3, resulting in the removal of power from image intensifier 14. As a result, image intensifier 14 is not subjected to what are likely to be excessive light intensities while under power. Accordingly, with switch 80 in the open position, there is no power applied to image intensifier 14, and image intensifier 14 can therefore sustain exposure to light without damage.

If desired, a standard 35 mm SLR camera mounted with a standard photographic lens may be connected directly behind eyepiece 120. The same way a user of such a camera sees the intensified image with his eye through the eyepiece 120, a 35 mm SLR camera, equipped with its photographic lens (its eye), will see through the eyepiece the same intensified image. See the description of FIG. 8 below.

If desired, an adapter which screws into chassis 20 in place of eyepiece 120 may be used to attach to a photographic film camera for permanently recording images produced by the inventive viewer 10. Referring to FIG. 6, such an adapter 136 has threads 138 that mate with the inside threads in chassis 20. At the other end, adapter 136 has mounting structure 140 similar to studs 70 which permit the inventive viewer 10 to be attached to an ordinary 35 mm camera 142 in much the same manner as a conventional 35 mm lens. Adapter 136 also includes optics 144 for the focusing the image from image intensifier 14 onto film 146 in the body of 35 mm camera 142 which has been equipped with the inventive viewer, as if the inventive viewer where a specialized lens or other accessory.

Viewfinder optics 148 of the type customarily used in a single lens reflex camera reflect the focused light image from the output of the image intensifier for viewing of the intensified image on the output of the image intensifier by a user 150.

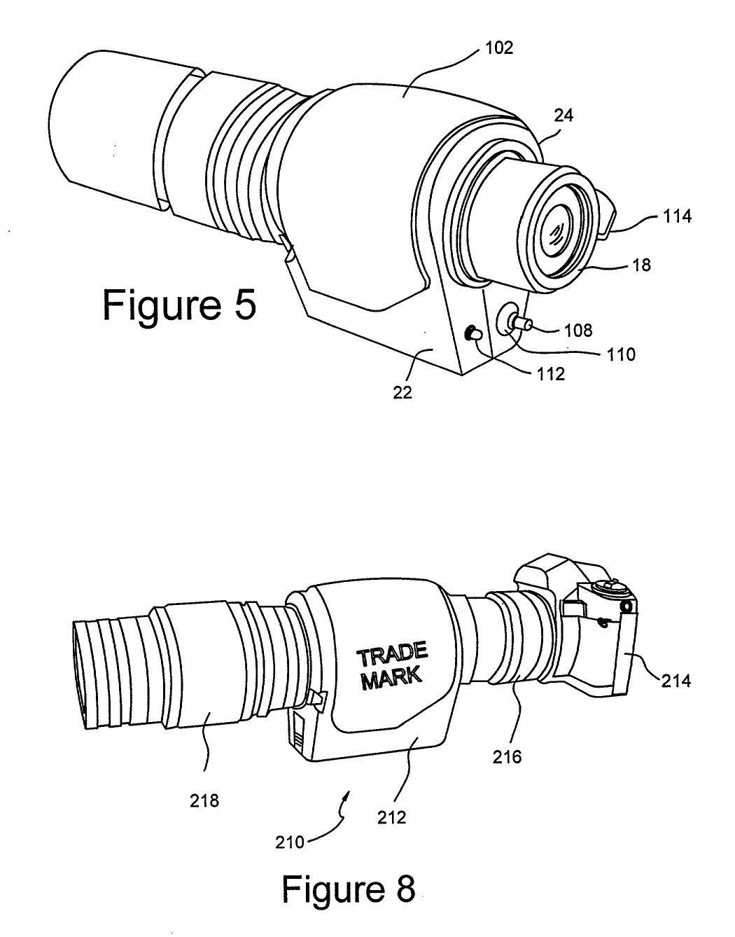

As shown in FIG. 7, then inventive viewer 10 may be comfortably gripped by the hand 180 of a user on account of the round top surface 182 of the same. Comfort and sure grip is promoted by narrow portion 184 and the grippable rubber surface of cowl 102.

In accordance with another embodiment of the invention, as illustrated in FIG. 8, inventive system 210 comprises an intensifier unit like that of the earlier embodiment including the inventive protection switch. A camera 214 with a lens 216 is optically and mechanically coupled to the output of intensifier 212. A lens 218 is coupled to intensifier 212 and when removed opens the protection switch.

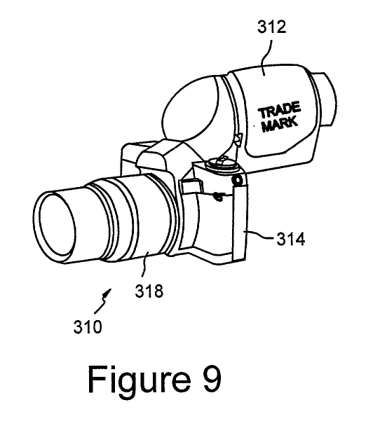

In accordance with another embodiment of the invention, as illustrated in FIG. 9, inventive system 310 comprises an intensifier unit, like that of the earlier embodiment, and including the inventive protection switch. An SLR camera 314 with a modified viewfinder optic 216 provides its viewfinder output to intensifier 312. Intensifier 312 is optically and mechanically coupled to the viewfinder output. A lens 218 is coupled to camera 314. When the intensifier 312 is removed from the viewfinder, coupling structure opens the protection switch situated between the intensifier and the viewfinder optic.

Several embodiments of the present invention are specifically illustrated and/or described herein. However, it will be appreciated that modification and variations of the present invention are covered by the above teachings and within the purview of the appended claims without departing from the spirit and intended scope of the invention.

What is claimed is:

1. An image intensifying forensic viewer, comprising:
(a) a lens configured to focus light, from an object or surface being imaged, as a focused light image;
(b) mounting structure disposed on said lens;
(c) an electrically powered image intensifier having an output and an input optically coupled to the lens to receive the focused light image from the lens and provide at the output of said image intensifier an intensified light image;
(d) a power source;
(e) a chassis configured to support said intensifier and to matingly engage said lens by engaging said mounting structure, said lens being engaged by said mounting structure in a use position; and
(f) an electrical switch having an open and a closed state, connected to couple electrical power from said power source to said image intensifier in said closed state and to decouple electrical power from said power source to said image intensifier in said open state, said electrical switch comprising an operator for configuring said electrical switch in the open state in an open operator position or in a closed state in a closed operator position, and said operator being urged into said closed operator position by said lens mounted on said chassis in said use position.

2. An image intensifying forensic viewer as in claim 1, wherein said lens is moveable, engaged by said mounting structure, between a use position and a release position to release said mounting structure and said lens in the release position.

3. An image intensifying forensic viewer as in claim 1, wherein said lens transmits ultraviolet light, said electrically powered image intensifier is sensitive to ultraviolet light and said lens is a focusable lens.

4. An image intensifying forensic viewer as in claim 1, wherein said lens has bayonet mounting structure configured to nest into and be rotated into engagement with mating bayonet mounting structure on said chassis.

5. An image intensifying forensic viewer as in claim 1, wherein said lens has snap mounting structure configured to snap into engagement with mating snap mounting structure on said chassis.

6. An image intensifying forensic viewer as in claim 1, further comprising viewing optics for presenting the output of said image intensifier to the eye of a viewer.

7. An image intensifying forensic viewer as in claim 1, further comprising viewing optics for presenting the output of said image intensifier to photographic film in a camera.

8. An image intensifying forensic viewer as in claim 1, wherein said operator is spring biased in said open operator

9. A forensic viewer according to claim 1, wherein the lens is an ultraviolet-transmissive, optionally quartz, lens.

10. A forensic viewer according to claim 1 comprising an ultraviolet filter for the camera lens.

11. A viewer according to claim 1 comprising an eyepiece coupled to the intensifier.

12. An ultraviolet forensic viewer according to claim 10 comprising a camera coupled to the intensifier.

13. An ultraviolet forensic viewer according to claim 1 wherein the intensifier is a first, second or third generation intensifier.

14. A forensic viewer as in claim 1, wherein said chassis comprises a housing with a round top and narrowed bottom and further comprising a hand strap coupled at two points to the side of said housing.

15. A forensic viewer as in claim 14, wherein said housing round top is made of a soft grippable material.

16. A forensic viewer as in claim 15, where in said housing is narrower at the bottom of the housing as compared to the top of the housing.
